(19) United States
(12) Patent Application Publication
(10) Pub. No.: US 2012/0023757 A1
(43) Pub. Date: Feb. 2, 2012

(54) Wafer cutting tool

(76) Inventor: Kenneth R. Schena, Naples, FL (US)

(21) Appl. No.: 12/804,913

(22) Filed: Aug. 2, 2010

(51) Int. Cl. B26B 25/00

(52) U.S. Cl. 30/272.1

(57) ABSTRACT

The inventive concept is directed to a circular cutting device, especially designed or used in cutting circular wafer in an ostomy application. The device consists of a handle having at one end thereof a circular backup plate. On top of the backup plate is located a plastic cutting receiving plate. The circular backup plate has at its center a threaded rod to receive a circular cup thereon. The cup has at its lower circular edge a razor-like cutting edge which will cut a perfect wafer when screwed down onto the plastic cutting receiving plate by way of the threaded rod.

### BACKGROUND OF THE INVENTION

There is a population of people that have undergone operations that have resulted in the establishment of what is called stoma. The stoma is a part of the colon or upper digestive track that has been routed through a hole that is cut by the surgeon in the abdominal wall to permit the expulsion of body waste. This bowel diversion can have resulted from any one number of causes including, but not limited to, cancer diverticulitis. Crones disease may be result of this type of surgical correction. The resulting surgery has created the need for a collection system to provide for the human body waste that can be expelled and must be collected for appropriate disposition.

There are a variety of pouch collection systems that have been designed to accommodate surrounding the stoma created to facilitate accumulation and disposal of this waste. The pouch systems come in one or two piece models that have a wafer and a bag. The two piece systems have two separate components that have a coupling mechanism that joins the parts together in an airtight connection. The one piece system come as a single unit with the wafer component permanently attached to the bag. Some such system manufacturers offer precut wafers in standard sizes to provide convenience to the user. The alternative is to use a special pair of scissors to cut the wafer hole to fit the stoma of the user. Stomas can vary in size and can change from the original size after the operation is completed.

The stomas having been created by the surgeon from an internal organ is very sensitive to an kind of rubbing or being bumped by a sharp object like a rough cut wafer or contact with a finger nail. Often the scissor cut will leave rough edges that can rub against the stoma resulting in bleeding.

### BRIEF DESCRIPTION OF THE INVENTION

The inventive concept is designed to cut a precision round hole in a variety of sizes to facilitate a comfortable fit which is free of abrasive edges and it is done with a minimal of effort. The base can be made from a variety of materials and the cutter is machined from stainless steel with a razor sharp cutting edge to facilitate fast easy customizing of the wafer.

### BRIEF DESCRIPTION OF THE DRAWINGS

FIG. 1 is a top view of the wafer cutting tool;

FIG. 2 is a side view of the cutting base of the tool;

FIG. 3 is a perspective view of the top of the cutter;

FIG. 4 is a perspective view of the basic tool.

The measurements shown in the drawings are for an examplenary indication only and have no bearing on the patentability of the of the invention. It is clear that many different measurements can be used.

### DETAILED DESCRIPTION OF THE INVENTION

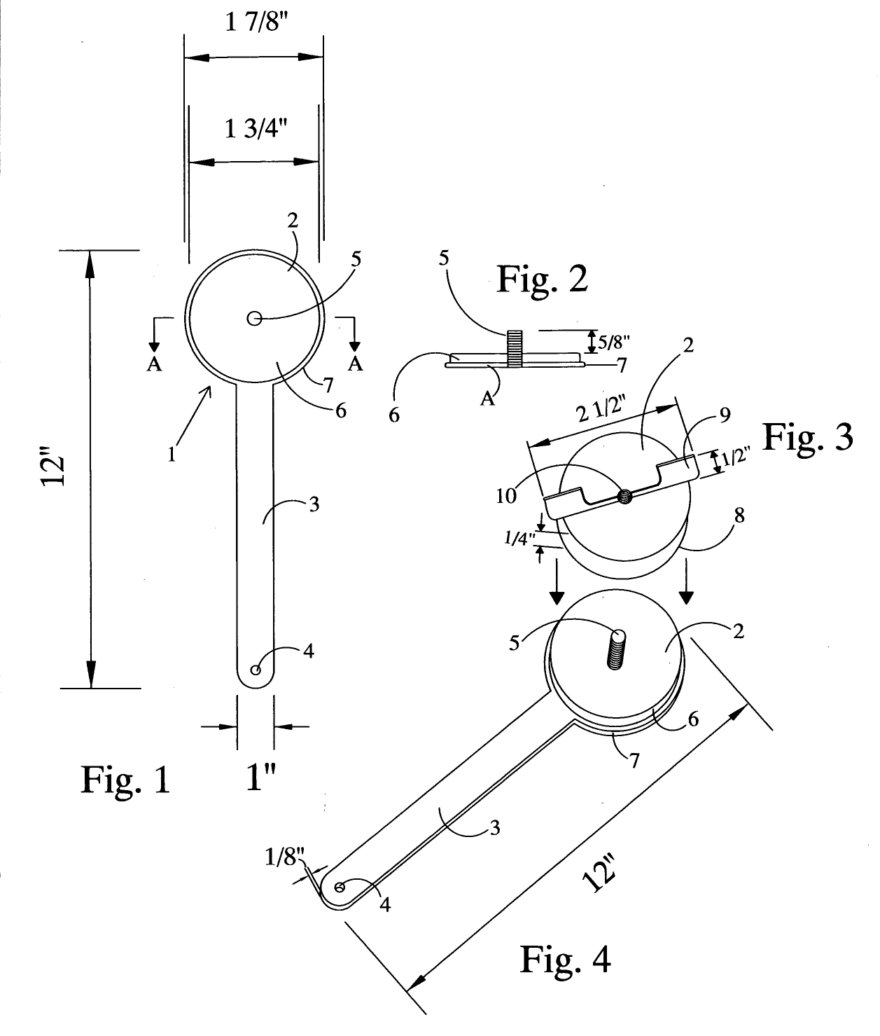

FIG. 1 shows a top view of the cutting tool 1. The tool 1 has at one end thereof a circular base 2 which is the backup disc when a material is being cut, as will be described below. The tool 1 has a handle 3 therein that is being used to handle the tool 1 in certain circumstances. The handle 3 has at one end thereof a hole 4 that is used to store the cutter 1 when not in use, like hanging it up. Also shown at the other end of the cutting tool there is a cutting location 7 which consists of the disc 2 in the form of a circular base as a back up such as a stainless steel. On top of the disc 2 there is located a NYLON disc 6 which forms the backup when a wafer is being cut.

FIG. 2 is a side view along the view of A [symbol] A of the cutting instrument, especially at the cutting end 2 of the tool 1. FIG. 2 shows the back-up plate 7 which receives a threaded rod 5 in its center. The back-up plate 7 has a NYLON plate 6 placed thereon. The plate 6 is the plate which will receive the cutting edge 8 (FIG. 3). The cutting edge 8 is at the bottom of the cup shaped cutter 2. The cup shaped cutter 2 has a finger grip 9 on top which is operated when the cutter is in operation. FIG. 4 is a perspective view of the Wafer cutter of FIG. 1 including the the backup plate 7 and the threaded rod 5.

### OPERATION

The EZ cutter consists of a base unit that will fit into a pouch and provide a NYLON cutting flat surface against which the circular cutting blade will compress in a circular motion to cut a hole in the wafer. The cutting blade is screwed onto the threaded post or rod after the base is in place either on a one piece system or the wafer of a two piece system. Three or four turns later the EZ-cutter has created a perfect smooth hole ready to accept an application of the user's abdomen. The EZ cutter cuts a perfect hole every time and can cut through just about any ostomy wafer on the market for Colostomy, Ileostomy and Urostomy patients with minimal effort including a separate label for sizing. In addition to the above noted application, the EZ cutter can be used to cut a precision hole for any application that uses cut-able material and requires sizing. The rotary cutting motion coupled with the guide post located in the base of the cutter assures a repeated cutting every time. The EZ cutter cab provided in many different sizes.

What I claim is:

1. A cutting device for cutting circular wafers, including a handle having at one end thereof a circular backup plate, said plate having a plastic cutter receiving plate thereon, said circular backup plate having a threaded rod at a center thereon, a circular cutting blade is attached to said threaded rod, said circular cutting blade cutting a perfect circular wafer when said circular cutting blade is rotationally activated.

2. The cutting device of claim 1, said circular cutting blade is part of a cup shaped implement at a bottom thereof.

3. The cutting device of claim 1, wherein said cup shaped implement has a finger portion on top of its surface.
